(19) United States
(12) Patent Application Publication
(10) Pub. No.: US 2022/0041303 A1
(43) Pub. Date: Feb. 10, 2022

(54) THRUST WITH THE MINIMUM EJECTION OF PROPELLANT

(71) Applicant: Everett Wade Willett, Caucel (MX)

(72) Inventor: Everett Wade Willett, Caucel (MX)

(21) Appl. No.: 16/985,070

(22) Filed: Aug. 4, 2020

(51) Int. Cl. B64G 1/40; F02K 9/42; F02K 9/08; F02C 6/20; B63H 7/02; B63H 11/00

(52) U.S. Cl. CPC B64G 1/409; F02K 9/42; F02K 9/08; B63H 11/00; F02C 6/206; B63H 7/02; F02C 6/20

(57) ABSTRACT

Thrust with the minimum ejection of propellant by a levitating mass blocking the exhaust stream within the propellant producing structure. The reaction of accumulated propellant pressure between the levitating mass the hollow passageway and the propellant producing engine create thrust thus propelling the propellant producing engine and the vehicle in which it is mounted. Fuel consumption is decrease because a significant amount of propellant is not allowed to escape and is trapped in the vehicle's structure. The levitating mass is not physically attached to the propellant producing engine or the vehicle's structure. The rated pounds of thrust can be significantly increase and is determine by the strength of the magnetic field holding the levitating mass in place the composition of the hollow passageway the mechanical and structural components of the propellant producing engine.

### BACKGROUND OF THE EMBODIMENT

### 1. Field of the Invention

The present embodiment relates to propulsion and specifically to a method and apparatus for producing thrust in a vehicle with the minimum ejection of propellant by a levitating mass blocking the exhaust stream.

### 2. Prior Art

In present day vehicle propulsion systems, the use of expelled propellant by an engine to produce large amounts of thrust, is widely used. The term thrust is defined to mean the amount of propulsive force developed by a propulsive engine. It is desirable to have the ration of thrust produce to the rate of fuel consumed to be as high as possible, this is generally referred to as specific impulse.

It is also known in the art of expelled propellant by an engine to produce thrust that can provide thrust to lift payloads from the earth's surface was achieved with the development of the rocket engine.

In a rocket engine's propulsion system, having a high specific impulse capability are highly desirable. The efficiency of a rocket motor is measured by a formula that compares what goes into the motor with what comes out. The output is thrust, generally measured in pounds. The input is fuel and oxidizer, having a certain rate, and is measured in pounds per second. If output is divided by input, that is, thrust equal to pounds cancel each other out and we are left with seconds as the unit of merit for the motor. This number is called specific impulse, or ISP. The higher the ISP, the better propulsive efficiency is concerned. Unfortunately rocket engines consume huge quantities of propellant that must be stored on the vehicle in order to launch small payloads. The size of the launch vehicle must be enormous in order to contain all the propellant.

It is also known in the art of expelled propellant by an engine to produce thrust that can provide the requisite to lift payloads from the earth's surface was also achieved with the development of jet engines. Jet technologies have been in existence since the 1930's and have probably reach their zenith in fuel consumption with the turbofan engine.

There are disclosures of proposed propulsion systems that generate propulsive forces without the ejection of propellant. One such application is a magnetohydrodynamic propulsion system which ionize the fluid medium surrounding the vehicle and through which the vehicle is moving. For example, U.S. Pat. No. 3,22,374 discloses a magnetohydrodynamic propulsion system that is believed to theoretically operate, but is is not a practical system because the system is believed to require an exceptionally large separate and independent power source that must be called to the vehicle. The system is further environmentally disadvantageous because it employs magnetic fields pulsating into the external atmosphere surrounding the vehicle. Another propulsion system that generate propulsive forces without the ejection of propellant is a electrostatic or field propulsion. Thrust is created by electrostatic accelerations of ions, created by an electron source in an electric field. Electrostatic propulsion system has limited thrust capabilities and takes a significantly amount of time to build up speed.

It has also, been suggested to use fluctuations in electrical circuit components to induce stationary forces. U.S. Pat. Nos. 5,280,864, 6,098,924 and 6,347,766. These proposed disclosures exist in theory and mathematical computation, and to date have no practical use.

The subject of the present embodiment is to make engines accelerate with the minimum ejection of propellant with increased fuel efficiency.

### SUMMARY

The primary objective of the embodiment is to significantly reduce fuel consumption of current propellant producing engines. Another objective of the embodiment is to significantly increase the speed of a vehicle travelling through space when the preferred embodiment is applied to a spacecraft. Further objectives of the embodiment is to reduce the audio signature produce by current propellant producing engines. Still another objective of the embodiment is to deplete the expulsion of harmful exhaust gases and by products produce by current propellant producing engines. Another aspect of the embodiment is to significantly reduce the harmful conditions of exhaust blast to humans, created by current propellant producing engines. A further aspect of the embodiment is to provide an efficient means of fuel consumption for transportation through space and the atmosphere which avoids the drawbacks of the prior art. It is another objective of the embodiment is to reduce the downward draft of air when the embodiment configuration corresponds to a helicopter or vertical landing vehicle. Further objects and advantages of the embodiment will become apparent from considerations of the drawings and ensuing description.

### BRIEF DESCRIPTION OF THE DRAWINGS

FIG. 2 is a basic example, cross sectional view of a levitating mass, hard capture apparatus hollow passageway, electromagnetic coil, levitating mass position sensor.

FIG. 4 is a basic example, cross sectional view of a propeller fora airplane, levitating mass, hard capture apparatus, hollow passageway, electromagnetic coil, levitating mass position sensor.

FIG. 6 is a basic example, cross sectional view of a jet engine, levitating mass, hard capture apparatus, hollow passageway, electromagnetic coil, levitating mass position sensor.

FIG. 8 is a basic example, cross sectional view of a turbo-fan engine, levitating mass, hard capture apparatus, hollow passageway, electromagnetic coil, levitating mass position sensor.

FIG. 10 is a basic example, cross sectional view of a liquid rocket engine, levitating mass, hard capture apparatus, hollow passageway, electromagnetic coil, levitating mass position sensor.

FIG. 12 is a basic example, cross sectional view of a solid propellant rocket engine, levitating mass, hard capture apparatus, hollow passageway, electromagnetic coil, levitating mass position sensor.

FIG. 14 is a basic example, cross sectional view of a water jet machine, levitating mass, hard capture apparatus, hollow passageway, electromagnetic coil, levitating mass position sensor.

FIG. 16 is a basic example, cross sectional view of a propeller for a boat, levitating mass, hard capture apparatus, hollow passageway, electromagnetic coil, levitating mass position sensor.

FIG. 18 is basic example, cross sectional view of a magnet inside the levitating mass, hollow passageway, position sensor for levitating mass, electromagnetic coil, hard capture apparatus, levitating mass.

FIG. 20 is a basic example, cross sectional view of a electromagnetic force field, electromagnetic coil, levitating mass position sensor, hollow passageway, hard capture apparatus, levitating mass.

### DETAILED DESCRIPTION

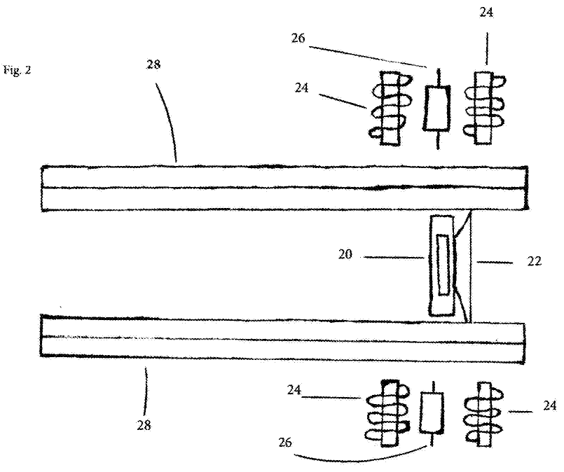

FIG. 2 is merely illustrative as there are numerous variations and modifications which made be made throughout the description. FIG. 2 is a basic example, partial, cross sectional view of a levitating mass 20, hard capture apparatus 22, electromagnet coil 24, levitating mass position sensor 26, hollow passageway 28. The levitating mass 20 could be but not necessarily designed in a circular configuration. The levitating mass 20 reside inside the hollow passageway 28 at a predetermine location to gain the most favorable results of the trapped propellant. The levitating mass 20 comprise the composition resistant to the maximum thermal range of accumulated propellant pressure trapped between the hollow passageway 28, and the, propellant producing engine. The levitating mass 20 levitates in mid-air and does not touch the internal surface of the hollow passageway 28 during operation. The external perimeter of the levitating mass 20 reside at a minimum distance from the internal surface of the hollow passageway 28. Fuel consumption is decrease because a significant amount of propellant is not allowed to escape and is trapped in the vehicle's structure. The reaction of accumulated propellant pressure between the levitating mass 20 the hollow passageway 28 and the propellant producing engine create thrust thus propelling the propellant producing engine and the vehicle in which it is mounted. The hard capture apparatus 22 could be but not necessarily designed in a circular configuration. The hard capture apparatus 22 reside inside the hollow passageway 28 at a predetermine location to gain the favorable results toward capturing the levitating mass 20. The hard capture apparatus 22 comprise the composition resistant to the maximum thermal range and pressure of accumulated propellant trapped between the levitating mass 20, hollow passageway 28 and the propellant producing engine. The hard capture apparatus 22 is physically attached to the hollow passageway 28. The hard capture apparatus 22 captures the levitating mass 20 during the vehicle's movement. The hard capture apparatus releases the levitating mass 20 in the electromagnetic field 46 before the movement of the vehicle. The hard capture apparatus 22 could be but not necessarily designed with an internal electromagnet to mate with the surface of the levitating mass 20. The electromagnetic coil 24 reside inside the hollow passageway 28 at a predetermine position to gain the most favorable results toward capturing the levitating mass 20. The electromagnetic coil 24 emits an electromagnetic field to capture the levitating mass 20. The electromagnetic coil 24 could be but not necessarily connected to a close loop feedback system that tells the electromagnetic coil 24 to turn on or off. The close loop feedback system could be but not necessarily designed with a optical sensor or linear hall effect sensor to gauge the position of the levitating mass 20. The close loop feedback system could be but not necessarily designed with push pull transistors or mosfet driver. The close loop feedback system could be but not necessarily designed with a control unit that processes electrical input and adjust the magnetic field strength accordingly. The hollow passageway 28 reside the vehicle's structure and direct the flow of propellant toward the levitating mass 20. The hollow passageway 28 comprise the composition resistant to the maximum thermal range and maximum propellant pressure. The hollow passageway 28 contains the propellant producing engine, levitating mass 20, hard capture apparatus 22, electromagnetic coil 24 levitating mass position sensor 26.

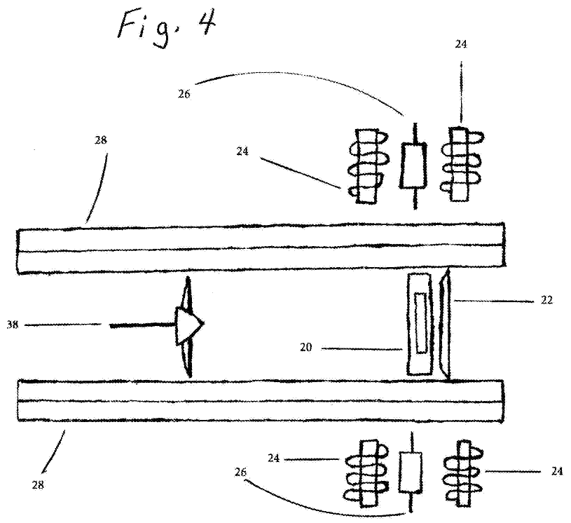

FIG. 4 is merely illustrative as there are numerous variations and modifications which may be made throughout the description. FIG. 4 is a basic example, partial, cross sectional view of a propeller 38 for an airplane. The propeller 38 reside inside the hollow passageway 28 at a predetermine location to gain the most favorable results of the trapped air between the levitating mass 20, hollow passageway 28 and the propeller 38. The propeller 38 comprise the composition resistant to the maximum air pressure and maximum thermal range of the trapped air between the levitating mass 20 and the hollow passageway 28.

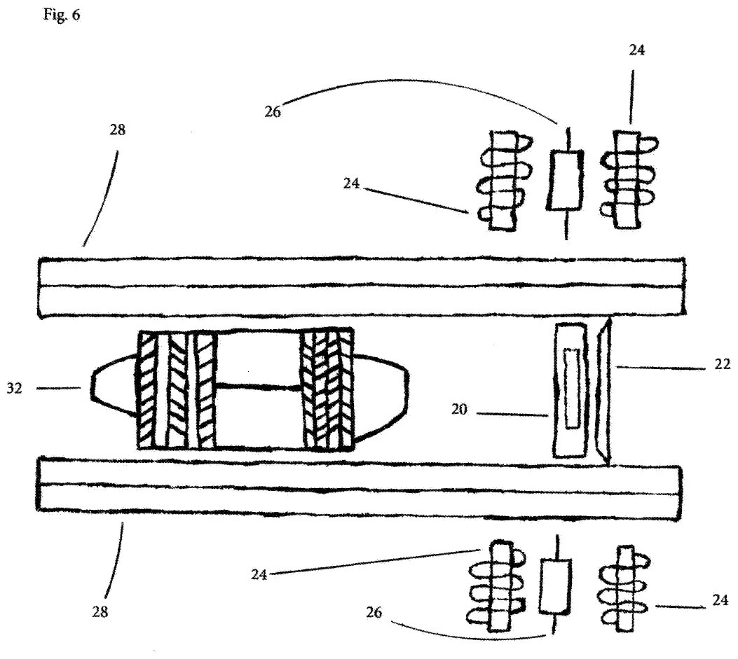

FIG. 6 is merely illustrative as there are numerous variations and modifications which may be made throughout the description. FIG. 6 is a basic example, partial, cross sectional view of a jet engine 32, levitating mass 20, hard capture apparatus 22, hollow passageway 28, electromagnetic coil 24, levitating mass position sensor 26. The jet engine 32 reside inside the hollow passageway at a predetermine location to gain the most favorable results of the trapped air between the levitating mass 20, hollow passageway 28 and the jet engine 32. The jet engine 32 comprise the composition resistant to the maximum air pressure and maximum thermal range of the trapped air between the, levitating mass 20 and the hollow passageway 28.

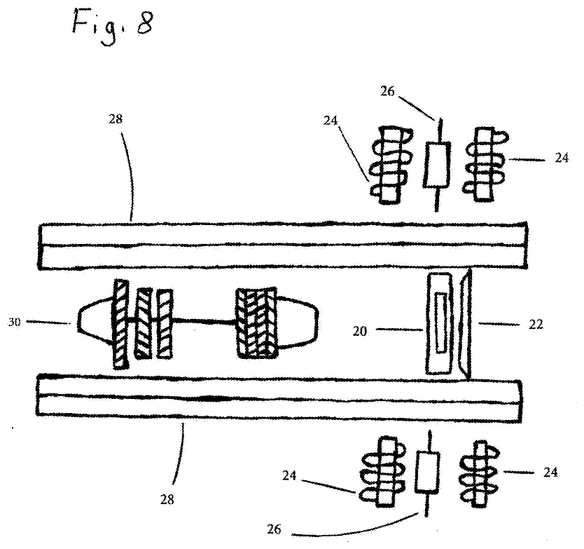

FIG. 8 is merely illustrative as there are numerous variations and modifications which may be made throughout the description. FIG. 8 is a basic example, partial, cross sectional view of a turbofan engine 30, levitating mass 20, hard capture apparatus 22, hollow passageway 28, electromagnetic coil 24, levitating mass position sensor 26. The turbo-fan engine 30 reside inside the hollow passageway 28 at a predetermine location to gain the most favorable results of the trapped air between the levitating mass 20, hollow passageway 28 and the turbo-fan engine 30. The turbo-fan engine 30 comprise the composition resistant to the maximum air pressure and maximum thermal range of the air trapped between the levitating mass 20 and the hollow passageway 28.

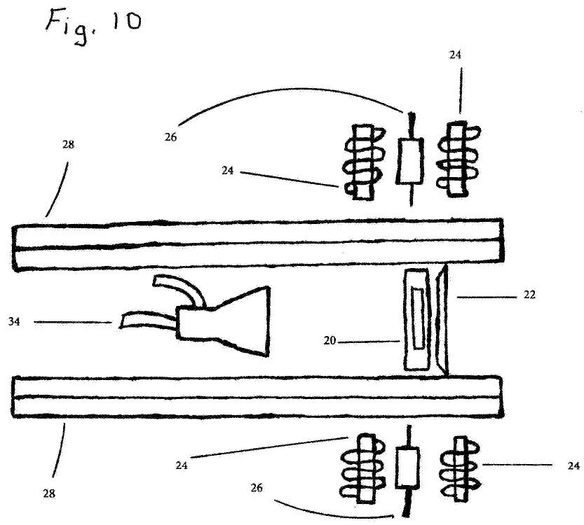

FIG. 10 is merely illustrative as there are numerous variations and modifications which made be made throughout the description. FIG. 10 is a basic example, partial, cross sectional view of a liquid rocket engine 34, levitating mass 20, hard capture apparatus 22, hollow passageway 28 electromagnetic coil 24, levitating mass position sensor 26. The liquid rocket engine 34 reside inside the hollow passageway 28 at a predetermine location to gain the most favorable results of the trapped propellant between the levitating mass 20 the hollow passageway 28 and the liquid rocket engine 34. The liquid rocket engine 34 comprise the composition resistant to the maximum thermal range and maximum propellant pressure trapped between the levitating mass 20 and the hollow passageway 28.

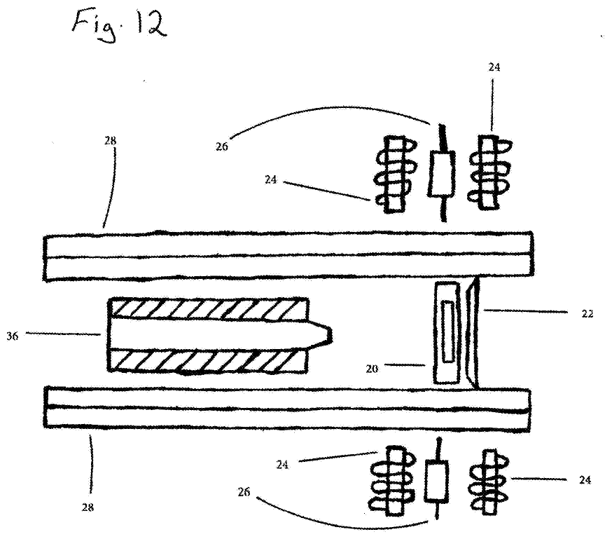

FIG. 12 is merely illustrative as there are numerous variations and modifications which made be made throughout the description. FIG. 12 is a basic example, partial, cross sectional view of a solid propellant rocket engine 36, levitating mass 20, hard capture apparatus 22, hollow passageway 28, electromagnetic coil 24, levitating mass position sensor 26. The solid propellant rocket engine 36 reside inside the hollow passageway 28 at a predetermine location to gain the most favorable results of the trapped propellant between the levitating mass 20 and the hollow passageway 28 and the solid propellant rocket engine 36. The solid propellant rocket engine 36 comprise the composition resistant to the maximum thermal range and maximum propellant pressure trapped between the levitating mass 20 hollow passageway 28 and solid propellant rocket engine 36.

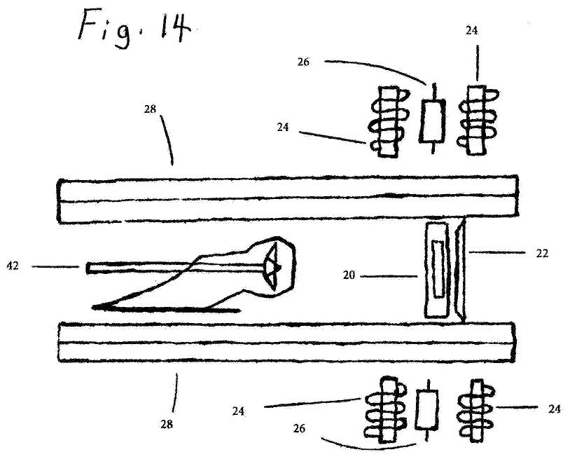

FIG. 14 is merely illustrative as there are numerous variations and modifications which made be made throughout the description.

FIG. 14 is a basic example, partial, cross sectional view of a water jet machine 42, levitating mass 20, hard capture apparatus 22, hollow passageway 28, electromagnetic coil 24, levitating mass position sensor 26. The water jet, machine 42 reside inside the hollow passageway 28 at a predetermine location to gain the most favorable results of the trapped water between the levitating mass 20, hollow passageway 28 and the water jet engine 42. The water jet machine 42 comprise the composition resistant to the maximum water pressure trapped between the levitating mass 20 hollow passageway 28 and the water jet machine 42.

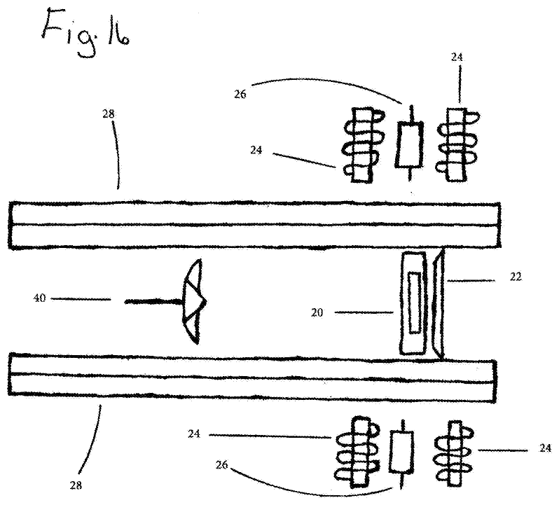

FIG. 16 is merely illustrative as there are numerous variations and modifications which may be made throughout the description. FIG. 16 is a basic example, partial, cross sectional view of a propeller 40 for a boat, levitating mass 20, hard capture apparatus 22 hollow passageway 28, electromagnetic coil 24, levitating mass position sensor 26. The propeller 40 reside inside the hollow passageway 28 at a predetermine location to gain the most favorable results of the trapped water between the levitating mass 20, hollow passageway 28 and the propeller 40.

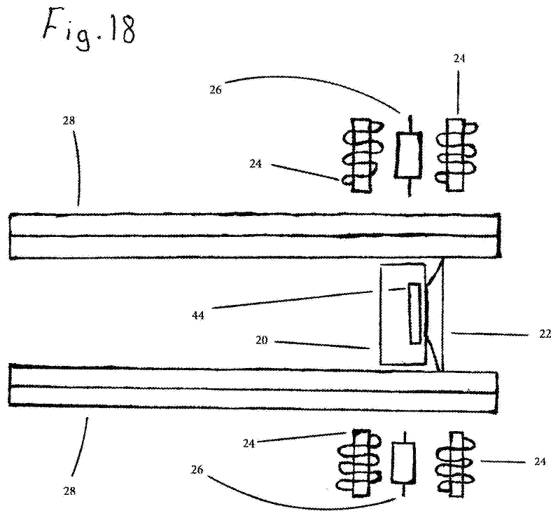

FIG. 18 is merely illustrative as there are numerous variations and modifications which may be made throughout the description. FIG. 18 is a basic example, partial, cross sectional view of an electromagnet 44, levitating mass 20, hard capture apparatus 22, electromagnetic coil 24, levitating mass position sensor 26. The electromagnet 44 reside inside the hard capture apparatus 22 to magnetically attract and capture the levitating mass 20 before and during non-operation. The electromagnet 44 also releases the levitating mass 20 in the magnetic field 46 in the precise and accurate position.

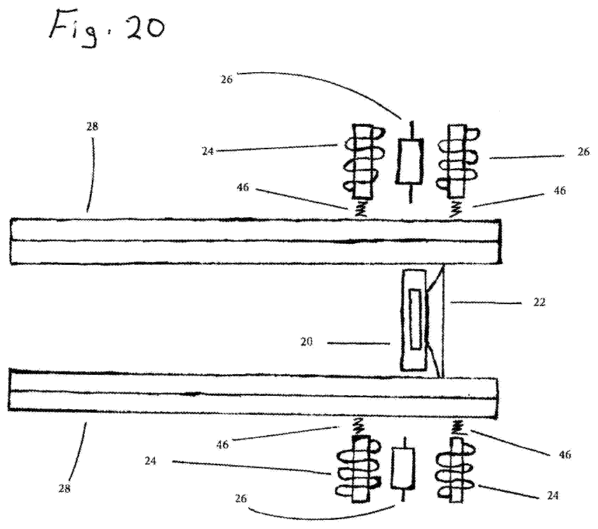

FIG. 20 is merely illustrative as there are numerous variations and modifications which may be made throughout the description. FIG. 20 is a basic example, partial, cross sectional view of a electromagnetic field 46, electromagnetic coil 24, levitating mass position sensor 26, hollow passageway 28, hard capture apparatus 22, levitating mass 20. The electromagnetic field 46 is generated by the electromagnetic coil 24 at a predetermine position and permeate through the hollow passageway 28 to levitate the levitating mass 20 in the proper position.

17. Apparatus for producing thrust in the vehicle with the minimum ejection of propellant comprising the levitating mass, hard capture apparatus, hollow passageway, electromagnetic coil, levitating mass position sensor, push pull electronic switch, close loop feedback system, micro controller, propellant producing engine.

18. The invention of claim 17 further comprising the levitating mass, hard capture apparatus, hollow passageway, propellant producing engine have the composition resistant to the maximum propellant pressure and the maximum thermal range of trapped propellant.

19. The invention of claim 17 further comprising the levitating mass constructed with permanent magnet.

20. The invention of claim 17 further comprising the levitating mass constructed with metal structure and metal surface.

21. The invention of claim 17 further comprising hard capture apparatus capturing levitating mass during non-operation of vehicle and releases levitating mass in electromagnetic field before vehicle's movement.

22. The invention of claim 17 further comprising hard capture apparatus is physically attached to hollow passage way and contains electrical magnet.

23. The invention of claim 17 further comprising electromagnetic coils to provide magnetic fields to levitate levitating mass and push pull electronic switch to maintain a stable levitating mass.

24. The invention of claim 17 further comprising levitating mass position sensor to provide the signal to push pull electronic switch and micro controller.

25. The invention of claim 17 further comprising close loop system to control magnetic electrical power and micro controller to process electronic and electrical information and adjust strength of magnetic field.

26. The invention of claim 17 further comprising thrust in a vehicle designed for usage through the atmosphere and space with a liquid propellant rocket engine.

27. The invention of claim 17 further comprising thrust in a vehicle for usage through the atmosphere and space with a solid propellant rocket engine.

28. The invention of claim 17 further comprising thrust in a vehicle designed for usage through the atmosphere with a jet engine.

29. The invention of claim 17 further comprising thrust in a vehicle designed for usage through the atmosphere with a turbo-fan engine.

30. The invention of claim 17 further comprising thrust in a vehicle designed for usage through the atmosphere with a propeller.

31. The invention of claim 17 further comprising thrust in a vehicle designed for usage on top of the water with a propeller.

32. The invention of claim 17 further comprising thrust in a vehicle designed for the usage underwater with water jet machine.
